(19) United States
(12) Patent Application Publication
(10) Pub. No.: US 2026/0211404 A1
(43) Pub. Date: Jul. 23, 2026

(54) PROCESSING METHOD FOR PROCESSING WORKPIECE BY PROCESSING TOOL

(71) Applicant: DISCO CORPORATION, Tokyo (JP)

(72) Inventor: Wenhua LIANG, Tokyo (JP)

(21) Appl. No.: 19/424,383

(22) Filed: Dec. 18, 2025

(30) Foreign Application Priority Data
Jan. 22, 2025 (JP) 2025-009420

(51) Int. Cl. G05B 19/418

(52) U.S. Cl. CPC G05B 19/41875; G05B 2219/32368

(57) ABSTRACT

Provided is a processing method including processing a second workpiece by a second processing tool in a processing apparatus having a memory in which a determination condition for diagnosing a state at a time of processing is stored, the determination condition being created by, on the basis of a first load value applied to a first workpiece or a first processing tool and first processing information other than the first load value which information is associated with processing of the first workpiece, in the processing the second workpiece by the second processing tool, obtaining a second load value applied to the second workpiece or the second processing tool and second processing information other than the second load value which information is associated with the processing of the second workpiece, and diagnosing a state of the second workpiece being processed by the second processing tool.

### BACKGROUND OF THE INVENTION

### Field of the Invention

The present invention relates to a processing method for processing a workpiece by a processing tool, a method for creating a determination condition, and a processing apparatus that processes a workpiece.

### Description of the Related Art

In a process for manufacturing semiconductor devices, workpieces such as semiconductor wafers are polished by a polishing pad in some cases. In the polishing, if wearing of a polishing tool, an abrupt change in processing load, or other abnormality occurs, it may not be possible to appropriately process the workpiece.

To cope with this problem, it has been a usual practice that a skilled operator recognizes difference in sound generated at the time of processing, thereby determining occurrence of an abnormality. However, this technique of recognizing difference in sound generated at the time of processing has a disadvantage that operators are significantly limited since they need to be highly skilled and another disadvantage that variations occur in determination since the determination depends on feelings.

Meanwhile, there is a method for determining occurrence of an abnormality by use of, for example, a technique of monitoring the value of current flowing through a motor used to rotate a spindle to which the tool is mounted (i.e., spindle current value) (refer to Japanese Patent Laid-open No. 2011-143516, for example).

However, in a period from the start to end of the processing a single workpiece, the spindle current value generally tends to increase as the processing advances toward its end, and hence, it is not necessarily reasonable to determine occurrence of an abnormality in the processing on the basis of whether or not the spindle current value has exceeded a predetermined threshold.

### SUMMARY OF THE INVENTION

The present invention has been made in view of such problems, and it is an object of the present invention to provide a new method that allows appropriate detection regarding whether or not an abnormality has occurred in processing.

In accordance with a first aspect of the present invention, there is provided a processing method for processing a workpiece by a processing tool, including processing a second workpiece by a second processing tool in a processing apparatus having a memory in which a determination condition for diagnosing a state at a time of processing is stored, the determination condition being created by, on the basis of a first load value applied to a first workpiece or a first processing tool and first processing information other than the first load value which information is associated with processing of the first workpiece, the first load value and the first processing information each being obtained while the first workpiece is being processed by the first processing tool, classifying the first processing information according to the first load value, in the processing the second workpiece by the second processing tool, obtaining a second load value applied to the second workpiece or the second processing tool and second processing information other than the second load value which information is associated with the processing of the second workpiece, and diagnosing a state of the second workpiece being processed by the second processing tool, according to the determination condition for the first load value corresponding to the second load value.

Preferably, storing the determination condition in the memory includes classifying data including the first load value and the first processing information each obtained at the time of processing the first workpiece into a plurality of groups according to the first load value, and creating the determination condition for each group on the basis of the data having been classified into the plurality of groups.

Preferably, the storing the determination condition in the memory of the processing apparatus includes, before the classification of the data into the plurality of groups, selecting and keeping part of the data which part is to be used in the classification into the plurality of groups.

Preferably, the first processing tool and the second processing tool each have a polishing pad, the determination condition is obtained when one surface of the first workpiece is polished by the first processing tool, and, in the diagnosing the state of the second workpiece being processed, one surface of the second workpiece is polished by the second processing tool, and the state of the second workpiece being polished by the second processing tool is diagnosed according to the determination condition.

In accordance with a second aspect of the present invention, there is provided a method for creating a determination condition, including classifying data including a load value applied to a workpiece or a processing tool and processing information other than the load value which information is associated with processing of the workpiece, the load value and the processing information each being obtained while the workpiece is being processed by the processing tool, into a plurality of groups according to a magnitude of the load value, and, on the basis of the data having been classified into the plurality of groups, creating a determination condition for diagnosing a state of the workpiece being processed, for each group.

In accordance with a third aspect of the present invention, there is provided a processing apparatus that processes a workpiece, including a holding table for holding the workpiece, a spindle to which a processing tool is mounted, and a controller that has a processor and a memory and controls operation of the holding table and the spindle. Stored in the memory is a determination condition for diagnosing a state at a time of processing, the determination condition being created by, on the basis of a first load value applied to a first workpiece or a first processing tool and first processing information other than the first load value which information is associated with processing of the first workpiece, the first load value and the first processing information each being obtained while the first workpiece is being processed by the first processing tool, classifying the first processing information according to the first load value. The controller obtains, in processing a second workpiece by a second processing tool mounted to the spindle, a second load value applied to the second workpiece or the second processing tool and second processing information other than the second load value which information is associated with the processing of the second workpiece, and diagnoses a state of the second workpiece being processed by the second processing tool, according to the determination condition for the first load value corresponding to the second load value.

In the processing method according to the first aspect of the present invention, first, the second workpiece is processed by the second processing tool in the processing apparatus having the memory in which the determination condition for diagnosing the state at the time of processing is stored, the determination condition being created by, on the basis of the first load value applied to the first workpiece or the first processing tool and first processing information other than the first load value which information is associated with processing of the first workpiece, the first load value and the first processing information each being obtained while the first workpiece is being processed by the first processing tool, classifying the first processing information according to the first load value.

Further, in the processing the second workpiece by the second processing tool, the second load value applied to the second workpiece or the second processing tool and the second processing information other than the second load value which information is associated with the processing of the second workpiece are obtained. Then, the state of the second workpiece being processed by the second processing tool is diagnosed according to the determination condition for the first load value corresponding to the second load value.

Since the determination condition individually set according to the load value is used in this manner, it is possible to more suitably detect whether or not an abnormality has occurred in the processing, compared to a case in which occurrence of an abnormality in the processing is detected on the basis of only whether or not the spindle current value has exceeded a threshold value.

The method for creating a determination condition according to the second aspect of the present invention includes classifying data including the load value applied to the workpiece or the processing tool and the processing information other than the load value which information is associated with the processing of the workpiece, the load value and the processing information each being obtained while the workpiece is being processed by the processing tool, into the plurality of groups according to the magnitude of the load value, and, on the basis of the data having been classified into the plurality of groups, creating the determination condition for diagnosing the state of the workpiece being processed, for each group. When the state of the second workpiece being processed by the second processing tool is diagnosed according to this determination condition, it is possible to more suitably detect whether or not an abnormality has occurred in the processing.

Further, in the processing apparatus according to the third aspect of the present invention, the controller of the processing apparatus obtains, in the processing the second workpiece by the second processing tool mounted to the spindle, the second load value applied to the second workpiece or the second processing tool and the second processing information other than the second load value which information is associated with the processing of the second workpiece, and diagnoses the state of the second workpiece being processed by the second processing tool, according to the determination condition for the first load value corresponding to the second load value. Therefore, it is possible to more suitably detect whether or not an abnormality has occurred in the processing.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a flowchart of a processing method;

FIG. 2 is a flowchart illustrating a method for causing a determination condition to be stored in a memory of a polishing apparatus;

FIG. 3 is a side view of a chuck table and a polishing unit, partially illustrated in cross section;

FIG. 4 is a top view of the chuck table and the polishing unit;

FIG. 5A is an example of a screen displaying whole data prior to data selection;

FIG. 5B is an example of a screen displaying data included in processing ID number 1;

FIG. 6 is an example of a screen displaying whole data kept after data selection;

FIG. 7A is an example of a screen displaying data examples classified into group 1;

FIG. 7B is an example of a screen displaying data examples classified into group 2;

FIG. 7C is an example of a screen displaying data examples classified into group 300;

FIG. 8 is a view illustrating an example of the determination condition for group 1;

FIG. 9 is a view illustrating an example of second processing information obtained;

FIG. 10 is a flowchart illustrating a method for diagnosing a state of a wafer being processed;

FIG. 11 is a scatter diagram indicating presence/absence of surface burning on the basis of a load value (horizontal axis) and load 3 (vertical axis);

FIG. 12 is a scatter diagram indicating presence/absence of surface burning on the basis of the load value (horizontal axis) and a spindle current value (vertical axis);

FIG. 13 is a scatter diagram indicating the load value (horizontal axis) and load 3 (vertical axis) according to presence/absence of edge cracking; and

FIG. 14 is a scatter diagram indicating the load value (horizontal axis) and the spindle current value (vertical axis) according to presence/absence of edge cracking.

### DETAILED DESCRIPTION OF THE PREFERRED EMBODIMENT

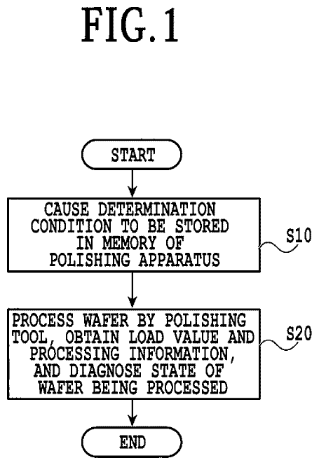

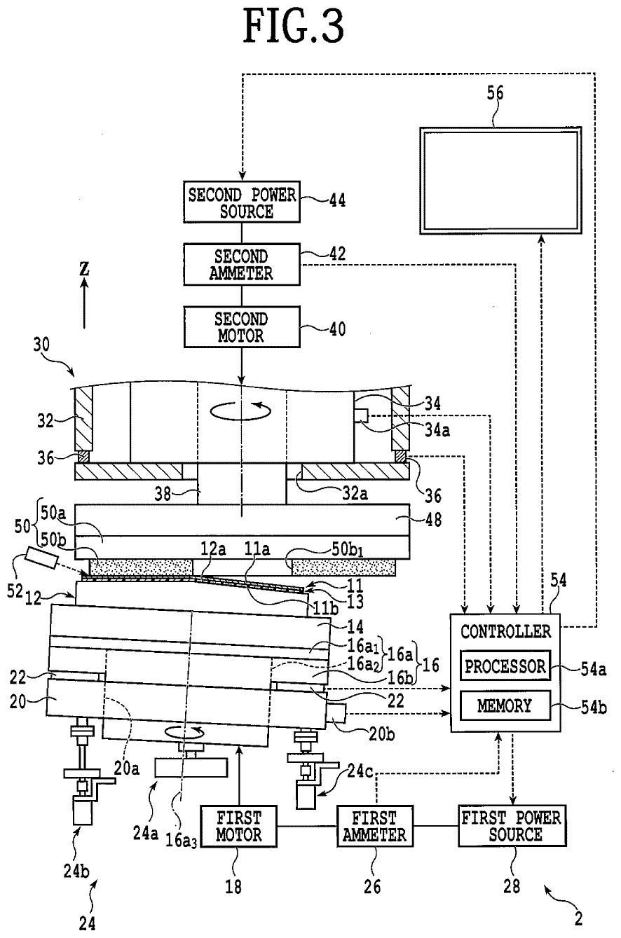

An embodiment according to an aspect of the present invention is described with reference to the accompanying drawings. FIG. 1 is a flowchart of a processing method for processing a wafer (i.e., workpiece or second workpiece) 11 (refer to FIG. 3) by a polishing tool 50 (refer to FIG. 3).

In the present embodiment, as illustrated in FIG. 1, the following steps are performed: causing a determination condition to be stored in a memory 54b of a polishing apparatus 2 (refer to FIG. 3) (S10); and obtaining a load value (i.e., second load value) and processing information (i.e., second processing information) while processing the wafer 11 by the polishing tool 50, and diagnosing a state of the wafer 11 being processed (S20).

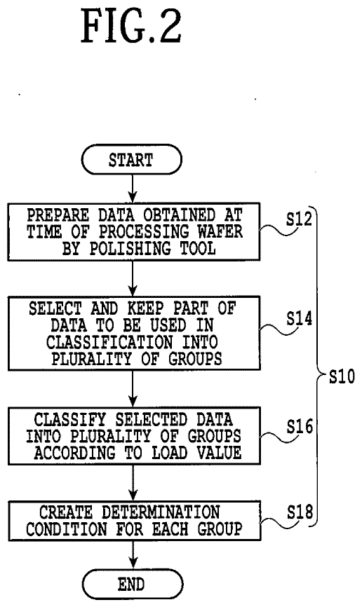

As illustrated in FIG. 2, the causing the determination condition to be stored in the memory 54b of the polishing apparatus 2 (S10) includes steps of preparing data obtained at the time of processing a wafer (i.e., first workpiece) 11 (S12), selecting and keeping part of data to be used in classification of data into a plurality of groups (S14), classifying the selected data into the plurality of groups according to the load value (S16), and creating a determination condition for each group (S18).

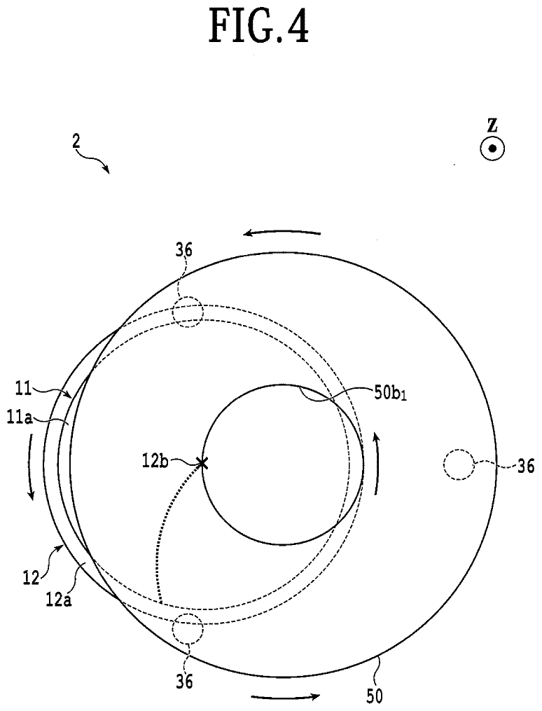

First, with reference to FIG. 3 and FIG. 4, the polishing apparatus (i.e., processing apparatus) 2 that polishes (i.e., processes) the wafer 11 is described. FIG. 3 is a side view of a chuck table 12 and a polishing unit 30, partially illustrated in cross section, and FIG. 4 is a top view of the chuck table 12 and the polishing unit 30. It is to be noted that some components are illustrated as functional blocks in FIG. 3. An arrow indicated as a Z axis in FIG. 3 and FIG. 4 represents an upward direction and is parallel with a vertical direction.

The chuck table (i.e., holding table) 12 is in the shape of a disk. An upper surface (i.e., holding surface 12a) of the chuck table 12 has a center portion slightly protruding (by only an amount of approximately 10 to 30 μm, for example) in comparison with an outer peripheral edge thereof, but this protruding amount is exaggerated in the illustration of FIG. 3.

The chuck table 12 has a fine non-porous disk-shaped frame body made of ceramic such as alumina. At a central portion of the frame body, a disk-shaped recessed portion is provided. In the recessed portion, a porous plate made of ceramic such as alumina is provided. The porous plate is fixed to the frame body through an adhesive or the like.

Upper surfaces of the frame body and the porous plate are substantially flush with each other and constitute the holding surface 12a. A suction source (not illustrated) such as a vacuum pump is connected to the frame body through a rotary joint (not illustrated), and when a negative pressure is transmitted from the suction source to the holding surface 12a, the wafer 11 placed on the holding surface 12a is held under suction by the holding surface 12a.

The chuck table 12 is mounted to a disk-shaped table base mount 14. The table base mount 14 is rotatably supported by an air bearing 16. The air bearing 16 has a rotor 16a and a stator 16b.

The rotor 16a has a disk-shaped large-diameter portion 16a₁ and a columnar small-diameter portion 16a₂ disposed concentrically at a position directly below the large-diameter portion 16a₁. The stator 16b in a ring shape is disposed at a position below the large-diameter portion 16a₁ and around the small-diameter portion 16a₂.

The rotor 16a and the stator 16b are not in contact with each other and have a slight gap (not illustrated) formed therebetween. This gap is formed by compressed air supplied from an unillustrated air supply source.

To a lower end portion of the small-diameter portion 16a₂ of the rotor 16a, a driven pulley (not illustrated) is fixed. Further, in the vicinity of the small-diameter portion 16a₂, a first motor 18 such as a servomotor is provided. A drive pulley (not illustrated) is fixed to an output shaft of the first motor 18, and an endless belt (not illustrated) is wound around the drive pulley and the driven pulley.

When the first motor 18 is activated, rotational power is transmitted to the rotor 16a. In FIG. 3, transmission of the power is simply indicated by an arrow. The rotor 16a rotates while keeping the non-contact state between the rotor 16a and the stator 16b. The rotation of the rotor 16a causes the chuck table 12 to rotate.

The stator 16b is supported on an annular table base 20. At a radially central portion of the table base 20, a through-hole 20a is formed. Through the through-hole 20a, the small-diameter portion 16a₂ is inserted without making contact with the table base 20.

A plurality of lower-side load sensors 22 each having a disk shape are provided at such positions on an upper surface of the table base 20 as to surround the through-hole 20a. In the present example, three lower-side load sensors 22 are supported on the table base 20 and disposed at substantially equal intervals along a circumferential direction of the through-hole 20a.

Each of the lower-side load sensors 22 detects a load applied downward to the chuck table 12. However, the number of lower-side load sensors 22 is not limited to three. It is sufficient if the table base 20 is provided with at least one lower-side load sensor 22 positioned in the vicinity of a contact area between a polishing pad 50b and the wafer 11.

The lower-side load sensor 22 is, for example, a diaphragm load cell but may be a column load cell. The load cell includes a sensor that converts a load into an electric signal. For example, the load cell includes a piezoelectric sensor having a piezoelectric element but may include a strain gauge sensor, a capacitive sensor, or the like in place of the piezoelectric sensor.

An upper surface of the lower-side load sensor 22 is in contact with a lower surface of the stator 16b. The force pressing the chuck table 12 downward is transmitted through the stator 16b to the lower-side load sensor 22. Since each lower-side load sensor 22 is connected to a controller 54 described later, the controller 54 can obtain information regarding the downward load applied to the chuck table 12 in real time.

The controller 54 in the present embodiment treats the sum of loads (i.e., load 1, load 2, and load 3 described later) obtained by the respective lower-side load sensors 22 during processing of the wafer 11 by the polishing tool 50, as a load value associated with the wafer 11.

That is, the load value (i.e., first load value or second load value) applied to the wafer 11 represents the sum of load 1 measured by the first lower-side load sensor 22, load 2 measured by the second lower-side load sensor 22, and load 3 measured by the third lower-side load sensor 22. Therefore, this load value may be read as a total load value.

Since the polishing apparatus 2 in the present embodiment has three lower-side load sensors 22, the sum of load 1, load 2, and load 3 is treated as the load value applied to the wafer 11. In a case in which the polishing apparatus 2 has N lower-side load sensors 22 (where N is a natural number), the sum of load 1 to load N is treated as the load value applied to the wafer 11.

Incidentally, in FIG. 3, one of the lower-side load sensors 22 and the controller 54 are connected to each other by a broken line, taking account of easy-to-see illustration. In actuality, however, all of the lower-side load sensors 22 are connected to the controller 54 in a wired or wireless manner.

The table base 20 is supported by an inclination adjustment mechanism 24. The inclination adjustment mechanism 24 adjusts an inclination of the table base 20 with respect to a plane (i.e., XY plane) orthogonal to the Z axis. The inclination adjustment mechanism 24 has a fixed support mechanism 24a, a first movable support mechanism 24b, and a second movable support mechanism 24c.

The fixed support mechanism 24a, the first movable support mechanism 24b, and the second movable support mechanism 24c are spaced apart from each other at substantially equal intervals along the circumferential direction of the through-hole 20a, and respective top portions of them are fixed to a lower surface of the table base 20.

The fixed support mechanism 24a, the first movable support mechanism 24b, and the second movable support mechanism 24c are disposed at positions not overlapping the lower-side load sensors 22 in a Z-axis direction. For example, when the table base 20 is viewed from above, the fixed support mechanism 24a, the first movable support mechanism 24b, the second movable support mechanism 24c, and the three lower-side load sensors 22 are positioned at vertices of a regular hexagon.

The fixed support mechanism 24a has a fixed shaft of a predetermined length, and this fixed shaft is not movable along the Z axis. By contrast, the first movable support mechanism 24b and the second movable support mechanism 24c each have a movable shaft formed at an upper end portion thereof with a male screw.

The upper end portion of each movable shaft is rotatably coupled to a screw hole of an upper support body fixed to the lower surface of the table base 20. To a lower end portion of each movable shaft, a drive source such as a servomotor or a pulse motor is coupled.

The movable shaft is rotatable by the drive source. By the drive source adjusting a screwing amount of the movable shaft into the upper support body, the inclination of the table base 20 with respect to the XY plane is adjusted. The rotor 16a is inclined following the inclination of the table base 20 in such a manner as to match the inclination of the table base 20.

The rotor 16a has an axis 16a₃ inclined by a minute angle with respect to the Z axis. More specifically, the axis 16a₃ is inclined by a minute angle such that a circular arc area on the holding surface 12a (area indicated by a circular arc broken line in FIG. 4) lies substantially in parallel with the XY plane.

The first motor 18 is connected to a first power source 28 through a first ammeter 26. The first ammeter 26 measures the value of current flowing to the first motor 18 and notifies the controller 54 of the current value. Thus, the controller 54 can obtain the value of current flowing to the first motor 18 in real time.

The first power source 28 includes a direct-current (DC) power source (not illustrated) and a predetermined circuit (not illustrated) for converting the voltage supplied from the DC power source to the first motor 18. The predetermined circuit is, for example, a circuit for converting the voltage supplied from the DC power source to the first motor 18, by use of the pulse width modulation (PWM) method or the linear method. By the controller 54 adjusting the voltage supplied through the first power source 28 to the first motor 18, the rotation speed of the chuck table 12 is controlled.

A vibration sensor 20b is fixed to a side portion of the table base 20. The vibration sensor 20b may be of a contact type that is provided in contact with an object to be measured, or may be of a non-contact type that is provided not in contact with and separated from the object to be measured. The vibration sensor 20b in the present embodiment is of the contact type and includes an acceleration sensor, a speed sensor, a displacement sensor, and the like.

The controller 54 uses the vibration sensor 20b to obtain the intensity, frequency, and the like of vibration generated when the table base 20, the table base mount 14, the chuck table 12, and the like vibrate in a unified manner.

The polishing unit 30 is provided above the chuck table 12. The polishing unit 30 is movable along the Z axis by a Z-axis direction feeding mechanism (not illustrated) including a ball screw, a motor, and the like.

The polishing unit 30 has a bottomed cylindrical holding member 32. The holding member 32 is coupled to the Z-axis direction feeding mechanism described above, and the polishing unit 30 moves along the Z axis when the holding member 32 moves along the Z axis. The holding member 32 has a hollow portion at a radially central portion thereof, and a cylindrical spindle housing 34 is provided in the hollow portion.

The spindle housing 34 is physically fixed to a bottom plate of the holding member 32. A vibration sensor 34a is fixed to a side portion of the spindle housing 34. The vibration sensor 34a is substantially identical to the vibration sensor 20b described above.

The controller 54 uses the vibration sensor 34a to obtain the intensity, frequency, and the like of vibration generated when a spindle 38, the polishing tool 50, and the like described later vibrate in a unified manner. A minute gap is provided between the bottom plate of the holding member 32 and a side plate of the holding member 32. In this gap, a plurality of (three, in the present embodiment) upper-side load sensors 36 are provided.

An upper surface of each upper-side load sensor 36 is fixed to a lower surface of the side plate of the holding member 32, and a lower surface of each upper-side load sensor 36 is fixed to an upper surface of the bottom plate of the holding member 32. That is, the bottom plate and the side plate of the holding member 32 are fixed to each other through the plurality of upper-side load sensors 36.

Each upper-side load sensor 36 is, for example, a diaphragm or column load cell. Due to force caused by the polishing unit 30's own weight and the like, downward force (i.e., tensile force) along the Z axis normally acts on each upper-side load sensor 36.

However, at the time of polishing, the polishing unit 30 moved by the Z-axis direction feeding mechanism presses the wafer 11 downward, and as a reaction to it, the polishing unit 30 receives upward force.

At this time, upward force (i.e., compressive force) acts on each upper-side load sensor 36. This compressive force reduces the tensile force acting on each upper-side load sensor 36. Thus, according to the reduction in tensile force acting on each upper-side load sensor 36, an upward load acting upward on the polishing unit 30 is detected.

Since each upper-side load sensor 36 is connected to the controller 54, the controller 54 can obtain the upward load acting on the polishing tool 50 in real time. The controller 54 treats the sum of loads (load 1, load 2, and load 3) obtained by the respective upper-side load sensors 36 during processing of the wafer 11 by the polishing tool 50, as a load value associated with the polishing tool (first processing tool or second processing tool) 50.

That is, in the present embodiment, the load value (i.e., first load value or second load value) applied to the polishing tool 50 represents the sum of load 1 measured by the first upper-side load sensor 36, load 2 measured by the second upper-side load sensor 36, and load 3 measured by the third upper-side load sensor 36. Therefore, this load value may be read as a total load value.

Since the polishing apparatus 2 in the present embodiment has three upper-side load sensors 36, the sum of load 1, load 2, and load 3 is treated as the load value applied to the polishing tool 50. In a case in which the polishing apparatus 2 has N upper-side load sensors 36 (where N is a natural number), the sum of load 1 to load N is treated as the load value applied to the polishing tool 50.

It is to be noted that, in FIG. 3, one of the upper-side load sensors 36 and the controller 54 are connected to each other by a broken line, taking account of easy-to-see illustration. In actuality, however, all of the upper-side load sensors 36 are connected to the controller 54 in a wired or wireless manner.

The spindle housing 34 houses therein part of the spindle 38 of a columnar shape in a rotatable manner. The spindle 38 is disposed such that its longitudinal direction extends along the Z axis. A second motor 40 such as a DC servomotor is provided in the spindle housing 34.

The second motor 40 functions as a spindle motor. The second motor 40 includes a rotor fixed to the spindle 38 and a stator provided to surround the rotor. The second motor 40 is connected to a second power source 44 through a second ammeter 42. The second ammeter 42 measures current flowing to the second motor 40 and notifies the controller 54 of the value of the current.

Thus, the controller 54 can obtain the value of the current flowing to the second motor 40 in real time. The second power source 44 includes a DC power source (not illustrated) and a predetermined circuit (not illustrated) for converting the voltage supplied from the DC power source to the second motor 40.

The predetermined circuit is, for example, a circuit for converting the voltage supplied from the DC power source to the second motor 40, by use of the PWM method or the linear method. By the controller 54 adjusting the voltage supplied through the second power source 44 to the second motor 40, the rotation speed of the spindle 38 is controlled.

The spindle 38 has a lower end portion protruding downward from a bottom surface of the holding member 32 through a through-hole 32a defined in the bottom plate of the holding member 32. To the lower end portion of the spindle 38, a disk-shaped mounter 48 is fixed.

The polishing tool 50 in an annular shape is fixed to a bottom surface of the mounter 48 by use of bolts (not illustrated). That is, to the lower end portion of the spindle 38, the polishing tool (processing tool, first polishing tool, or second polishing tool) 50 is mounted. The polishing tool 50 in the present embodiment is a dry polishing wheel which is used in what is generally called dry polishing.

The polishing tool 50 includes a disk-shaped base member 50a and the polishing pad 50b that is in an annular shape and is fixed to one surface of the base member 50a. The polishing pad 50b is a polishing layer in which abrasive grains made of diamond or the like are fixed to a base material made of hard polyurethane or the like by a binder in a state of being dispersed in the base material.

The polishing pad 50b has an opening 50b₁ defined at a central portion thereof and has a radial width substantially the same as the radius of the wafer 11, but the radial width is slightly smaller than the radius of the wafer 11 as illustrated in FIG. 4.

In the present embodiment, in a state in which the holding surface 12a and the wafer 11 are disposed concentrically, a rotation center 12b (refer to FIG. 4) of the holding surface 12a is positioned at an edge of the opening 50b₁ of the polishing pad 50b, and part of the wafer 11 is positioned on an outer side of an outer peripheral edge of the polishing pad 50b in a radial direction of the polishing pad 50b.

With reference back to FIG. 3, in the vicinity of the chuck table 12, there is provided a temperature sensor 52 for measuring the temperature of a contact area (also referred to as a processing point) between the polishing pad 50b and the wafer 11 in a non-contact manner. The temperature sensor 52 is a radiation thermometer or an optical thermometer.

The temperature sensor 52 is, for example, an infrared sensor, which is a typical example of the radiation thermometer, and calculates the temperature of the contact area between the polishing pad 50b and the wafer 11 according to infrared light or heat emitted from the contact area.

The polishing apparatus 2 includes the controller 54 that controls operation of the chuck table 12, the inclination adjustment mechanism 24, the spindle 38, the Z-axis direction feeding mechanism, and the like. The controller 54 is configured by, for example, a computer having a processor 54a typified by a central processing unit (CPU) and the memory 54b.

The memory 54b includes a main storage unit such as a dynamic random access memory (DRAM) and an auxiliary storage unit such as a flash memory. The auxiliary storage unit stores therein software including a predetermined program. Functions of the controller 54 are implemented by causing the processor 54a and the like to operate according to the software.

It is to be noted that the predetermined program executed by the processor 54a may be stored in, in place of the auxiliary storage unit, a non-transitory physical recording medium such as a universal serial bus (USB) memory, an optical disk, an SD memory card, or a hard disk drive (HDD).

The controller 54 is connected to a touch panel display 56. The touch panel display 56 functions as an input device used when an operator inputs an instruction to the controller 54, and functions also as a display device for displaying processing conditions, log data, and the like.

It is to be noted that, in place of the touch panel display 56, a display device not having the function of the input device may be provided to the polishing apparatus 2. In this case, however, an input device (keyboard, mouse, trackball, touch pad, digitizer, or the like) for the operator to input an instruction to the polishing apparatus 2 is provided separately.

When dry polishing is to be performed on the wafer 11, first, the wafer 11 is held under suction through a protective tape 13 on the holding surface 12a, the protective tape 13 being attached to another surface 11b of the wafer 11 such that one surface (i.e., surface to be processed) 11a of the wafer 11 is exposed upward.

Then, while the chuck table 12 and the polishing tool 50 are rotated at respective predetermined speeds, the polishing unit 30 is pressed against the wafer 11 with predetermined pressure by use of the Z-axis direction feeding mechanism. At this time, an area of the wafer 11 positioned in an area highest in the holding surface 12a (the highest area being indicated by the circular arc broken line in FIG. 4) is polished by the polishing pad 50b.

In the present embodiment, the wafer 11 (i.e., first workpiece) is polished (i.e., processed) by the polishing tool 50 (i.e., first polishing tool), and during the polishing (i.e., during the processing), the first load value applied to the wafer 11 and first processing information (i.e., first processing information other than the first load value) associated with the processing of the wafer 11 are individually obtained.

It is to be noted that the first load value is obtained by processing the first processing information. Specifically, after obtaining the first processing information, the controller 54 calculates the sum of load 1 to load 3 in the first processing information to obtain the first load value.

The first load value applied to the wafer 11 is the sum of load 1, load 2, and load 3 measured by the three respective lower-side load sensors 22 as described above. However, in place of the first load value applied to the wafer 11, the first load value applied to the polishing tool 50 which value is obtained during the polishing may be used. The first load value applied to the polishing tool 50 is the sum of load 1, load 2, and load 3 measured by the three respective upper-side load sensors 36 as described above.

Further, the first processing information includes (1) load 1, (2) load 2, (3) load 3, (4) rotation speed of the spindle 38, (5) value of current flowing to the second motor 40 (hereinafter referred to simply as a spindle current value), (6) position of the polishing tool 50 relative to the holding surface 12a in the Z-axis direction (hereinafter referred to simply as a Z position), (7) temperature of the contact area between the polishing pad 50b and the wafer 11 (hereinafter referred to simply as the temperature), (8) speed of downward movement of the polishing unit 30, (9) load torque of the motor included in the Z-axis direction feeding mechanism, (10) load torque of the first motor 18 for rotating the chuck table 12, and (11) rotation speed of the chuck table 12.

It is to be noted that the spindle current value in the present embodiment is calculated using as a reference the value of current flowing to the second motor 40 at the time of air cutting (i.e., when the polishing pad 50b is running idle above the wafer 11 without making contact with the wafer 11), and that the position of the polishing tool 50 relative to the holding surface 12a in the Z-axis direction is calculated using as a reference the position at which air cutting has started.

It is to be noted that the spindle current value need not necessarily be calculated using as a reference the value of current flowing to the second motor 40 at the air cut start position and may be calculated using as a reference the value of current flowing to the second motor 40 when air cutting is being performed with the polishing tool 50 at a position separated by a predetermined distance in the Z-axis direction from the upper surface (one surface 11a in the present example) of the wafer 11.

The first processing information further includes (12) vibration of the chuck table 12 measured by the vibration sensor 20b, (13) vibration of the spindle 38 measured by the vibration sensor 34a, (14) relative positions of the chuck table 12 and the polishing tool 50 in a predetermined direction (X-axis direction, for example) orthogonal to the Z axis, and (14) room temperature in a room where the polishing apparatus 2 is installed.

Although not used in the polishing apparatus 2 that performs dry polishing, in the case of performing wet polishing or other processing (grinding, cutting, or the like), the first processing information further includes (15) flow rate of polishing liquid or processing water supplied to the processing point as well as characteristics of the polishing liquid such as concentration, kind, temperature, and the like of the polishing liquid.

In addition, in a case in which the chuck table 12 is moved between a loading/unloading region and a processing region by an X-axis direction moving mechanism including a ball screw and a motor, the first processing information includes (16) load torque of the motor of the X-axis direction moving mechanism.

Moreover, in a case in which not the operator but a loading arm provided in the processing apparatus automatically transfers the wafer 11 from a cassette to the chuck table 12, the first processing information other than the first load value includes (17) load torque of a motor for actuating the loading arm. The controller 54 can obtain information regarding (1) to (17) at fixed time intervals (several to several tens of milliseconds, for example).

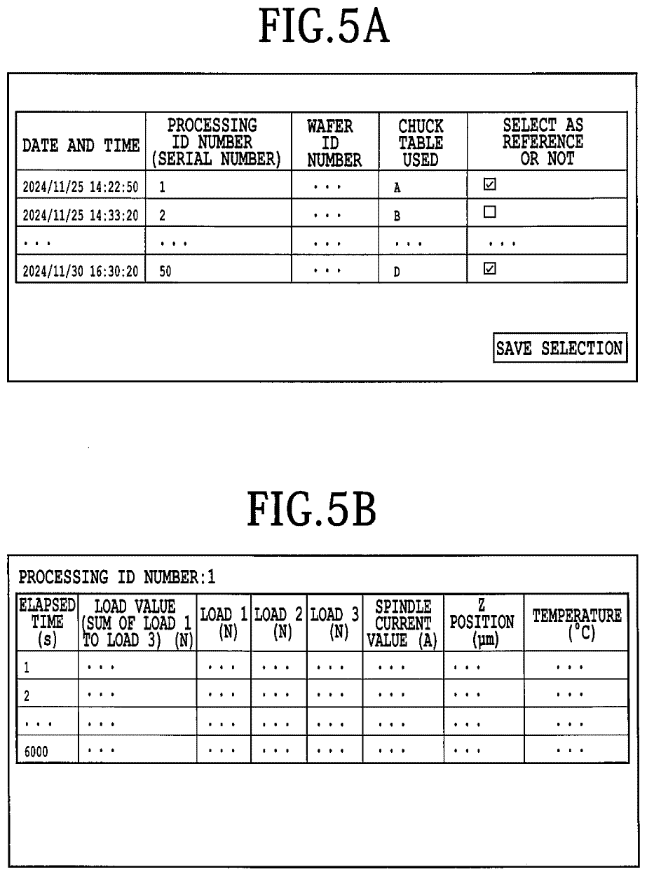

It is to be noted that (1) load 1, (2) load 2, (3) load 3, (5) spindle current value, (6) Z position, and (7) temperature are adopted as the first processing information in the present embodiment (refer to FIG. 5B), but, needless to say, the first processing information may include information other than those.

Next, with reference to FIG. 1, FIG. 2, and FIG. 5A to FIG. 14, the method for processing the wafer 11 (and the method for creating the determination condition) is described. In the present embodiment, first, the determination condition is stored in the memory 54b of the polishing apparatus 2 (S10). The storage of the determination condition in the memory 54b of the polishing apparatus 2 (S10) can be separated into the steps illustrated in FIG. 2.

FIG. 2 is a flowchart illustrating the method for causing the determination condition to be stored in the memory 54b of the polishing apparatus 2. S10 includes preparing data that was obtained at the time of processing the wafer (i.e., first workpiece) 11 by the polishing tool (i.e., first polishing tool) 50 (S12).

The data obtained at that time includes information regarding (1) to (17) described above. The preparation of data (S12) means, for example, establishing a state in which the memory 54b of the polishing apparatus 2 to be used stores therein data that was obtained in the same polishing apparatus 2 in the past.

In S12, it is preferable to use past data obtained using the same polishing apparatus 2. Using data obtained in the past by the same polishing apparatus 2 can enhance reliability of determination, compared to the case of using data obtained in the past by another polishing apparatus 2.

It is to be noted that old data can automatically be replaced with new data every time processing is completed, to thereby create a determination condition by use of the new data. Further, data obtained by another polishing apparatus 2 may be supplied to the polishing apparatus 2 that is to polish the wafer 11, through technical means such as wireless communication.

Needless to say, data transfer is not limited to the direct data transfer between the polishing apparatuses 2 through wireless communication, and it is also possible to perform data transfer between the polishing apparatuses 2 through a personal computer (PC), a server, or the like. After S12, part of data that is to be used in classification into a plurality of groups is selected and kept (S14).

FIG. 5A is an example of a screen of the touch panel display 56, the screen displaying whole data prior to data selection. It is to be noted that, in the table of FIG. 5A, a field with dots means that information is described in the field in actuality but is omitted from the illustration for convenience of explanation. The same is true for the subsequent figures.

FIG. 5A illustrates an outline of data obtained at the time of processing the wafer 11 by the polishing tool 50. The outline of data illustrated in FIG. 5A includes (i) date and time of obtainment of data, (ii) processing identification (ID) number, (iii) ID number of the wafer 11, (iv) chuck table 12 used, and (v) check box for specifying whether or not to select the relevant data.

(ii) processing ID number is a serial number assigned to each wafer 11 that has been polished, in the order of the polishing. (iii) ID number of the wafer 11 is a wafer-specific identification number assigned to each wafer 11 to be processed.

(iv) chuck table 12 used is the kind of the chuck table 12 actually used in polishing the wafer 11. On (v) check box, a check mark is put by the operator touching the box. It is to be noted that the operator can cancel the check mark by touching the box again.

The operator selects and keeps data regarding the wafer 11 for which the result of polishing has been satisfactory (i.e., non-defective wafer 11). The expression “the result of polishing has been satisfactory” means, for example, that, based on visual inspection by the operator, the degree of surface burning and chipping (i.e., cracking) observed is (a) equal to or smaller than a predetermined allowable value, (b) substantially zero, or (c) zero.

It is to be noted that, in place of visual inspection by the operator, image processing may be performed on an image obtained by imaging a polished surface after polishing, so that surface burning, chipping, in-plane variations in thickness of the wafer 11, and the like are quantitatively evaluated.

Incidentally, for the purpose of selecting and keeping the data regarding the wafer 11 for which the result of polishing has been satisfactory in this manner, in a case in which satisfactory processing result has been obtained in recent polishing, the data regarding the wafer 11 for which satisfactory processing result has been obtained may selectively be kept in the polishing apparatus 2 in advance. Thus, time and labor of the operator for performing selection in S14 can be saved.

It is to be noted that, in place of or in addition to selecting the data regarding the wafer 11 for which the result of polishing has been satisfactory, the operator may select data regarding the wafer (i.e., first workpiece) 11 having specifications not completely identical but similar to specifications of the wafer (i.e., second workpiece) 11 to be polished.

Examples of specifications of the wafer 11 include the thickness, size (diameter, for example), material, shape, and structure (single wafer or laminated wafer, for example) of the wafer 11.

Meanwhile, in addition to selectively keeping the data regarding the wafer 11 for which the result of polishing has been satisfactory, it is also possible to keep in advance as a record the quality (whether or not there is edge cracking, for example) of the wafer 11 before polished, and to put no check mark or to cancel the check mark once put if there has been an abnormality (edge cracking, for example) in the wafer 11 before polished. In the case in which the quality of the wafer 11 before polished is unsatisfactory (there is edge cracking, for example), it is highly likely that an abnormality occurs in the subsequent processing. Hence, it is preferable to exclude data regarding such wafer 11 in advance.

In the example illustrated in FIG. 5A, the operator has selected two pieces of data, i.e., data with processing ID numbers 1 and 50, among pieces of data obtained recently (refer to the field “SELECT AS REFERENCE OR NOT”). When the operator touches a “SAVE SELECTION” button after selection, the two pieces of data with processing ID numbers 1 and 50 are selected and kept as data to be used in classification into a plurality of groups.

It is to be noted that, in place of putting a check mark in the field for data desired to be selected and kept, it is also possible to put a check mark in the field for data desired to be excluded, to selectively exclude the data with the check mark in its check box.

FIG. 5B is an example of a screen of the touch panel display 56, the screen displaying data included in processing ID number 1. The data included in processing ID number 1 includes elapsed time(s), the load value (i.e., sum of load 1, load 2, and load 3) (N), load 1 (N), load 2 (N), load 3 (N), the spindle current value (A), the Z position (μm), and the temperature (°C.). It is to be noted that processing ID number 50 also includes similar data.

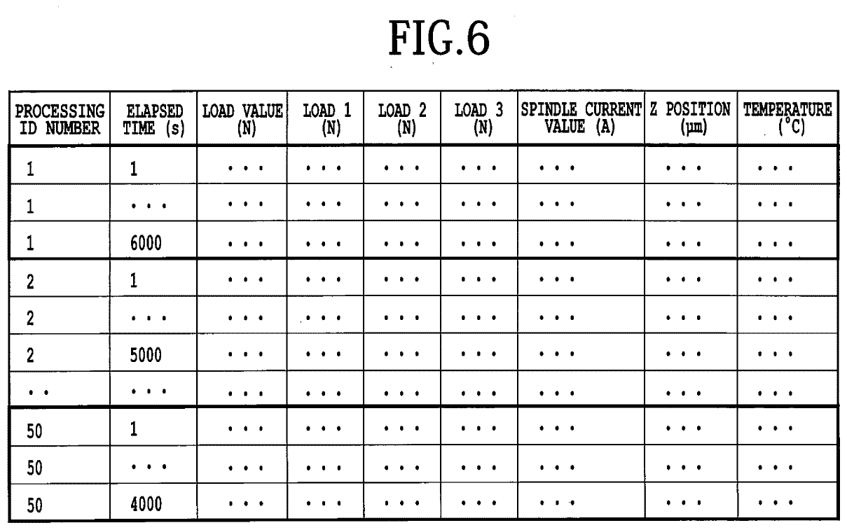

FIG. 6 is an example of a screen of the touch panel display 56, the screen displaying whole data kept after data selection. Since the “SAVE SELECTION” button has been touched with two processing ID numbers 1 and 50 selected, ranges of processing ID numbers 1 and 50 are highlighted.

After S14, the controller 54 classifies the data of processing ID numbers 1 and 50 into a plurality of groups according to the load value (S16). A predetermined program for executing classification (first program) is stored in the memory 54b (particularly, in the auxiliary storage unit), and the classification is executed by the processor 54a reading and executing the first program.

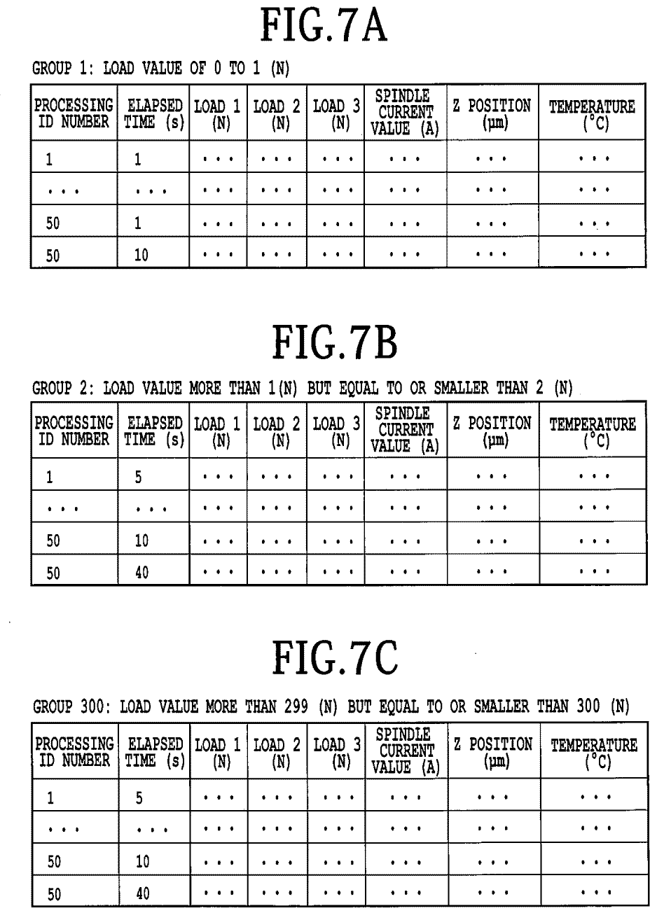

FIG. 7A is an example of a screen of the touch panel display 56, the screen displaying data examples classified into group 1. The data included in group 1 is data having a load value of 0 to 1 (N) and includes the processing ID number, the elapsed time(s), load 1 (N), load 2 (N), load 3 (N), the spindle current value (A), the Z position (μm), and the temperature (°C.).

FIG. 7B is an example of a screen of the touch panel display 56, the screen displaying data examples classified into group 2. The data included in group 2 is data having a load value more than 1 (N) but equal to or smaller than 2 (N) and includes information of kinds similar to those in group 1.

FIG. 7C is an example of a screen of the touch panel display 56, the screen displaying data examples classified into group 300. The data included in group 300 is data having a load value more than 299 (N) but equal to or smaller than 300 (N) and includes information of kinds similar to those in group 1.

Incidentally, the above-described closed interval and half-open intervals of the load value in the respective groups are mere examples, and the load value of group 1 may be equal to or larger than 0 (N) but smaller than 1 (N), the load value of group 2 may be equal to or larger than 1 (N) but smaller than 2 (N), and similarly, the load value of group 300 may be equal to or larger than 299 (N) but smaller than 300 (N).

In this manner, in the present embodiment, the data including the load value (i.e., first load value) and the processing information (first processing information) each obtained at the time of processing the wafer (first workpiece) 11 is classified into a plurality of groups according to the load value (i.e., first load value).

After S16, the controller 54 creates a determination condition for each group on the basis of the data classified into the plurality of groups (S18). A predetermined program for creating the determination condition (second program) is stored in the memory 54b (particularly, in the auxiliary storage unit), and the creation is executed by the processor 54a reading and executing the second program.

In the present embodiment, since the data of each group has a substantially normal distribution of values of each item such as load 1, load 2, and so on, a determination condition in which a 3σ range (i.e., range of mean μ±(3×standard deviation σ)) of numerical values of each item is regarded as a normal range is created.

It is to be noted that, in place of 3σ, a range of a minimum value X_{MIN} to a maximum value X_{MAX} may be regarded as a normal range, a range of (minimum value X_{MIN}−α) to (maximum value X_{MAX}+α) (where α is a predetermined value) may be regarded as a normal range, or any other range that is obtained through machine learning by the computer may be regarded as a normal range.

The determination condition created for each group according to the load value is stored in an area different from that for data in the memory 54b as the determination condition for use in diagnosing the state at the time of processing. For example, the determination condition is stored in a determination condition folder specifically labeled in the memory 54b.

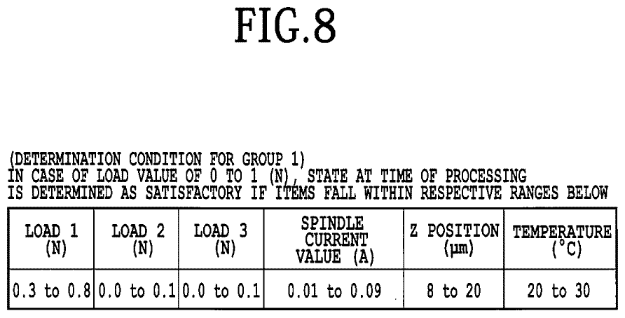

FIG. 8 is an example of a screen of the touch panel display 56, the screen displaying an example of the determination condition for group 1 among the plurality of groups, and filtering in the 3σ range has been performed for the numerical range of each item. The numerical range indicated in each of the items including load 1 (N), load 2 (N), and so on represents upper and lower limits of the 3σ range within which the state at the time of processing is diagnosed as being satisfactory.

Needless to say, determination conditions for all the groups, such as a determination condition that the load value is larger than 1 (N) but equal to or smaller than 2 (N) for group 2, a determination condition that the load value is larger than 2 (N) but equal to or smaller than 3 (N) for group 3, and so on, are stored in the memory 54b.

Since the determination conditions thus created are formed by selectively using the data regarding the wafer 11 for which the result of polishing has been satisfactory, they can be regarded as representing the normal range in the first processing information within which range normal polishing (i.e., processing) can be performed.

After completion of S10, the one surface 11a of the wafer (i.e., second workpiece) 11 is polished (i.e., processed) by the polishing tool (i.e., second processing tool) 50 mounted to the spindle 38 of the polishing apparatus 2 storing therein the determination conditions, and the controller 54 obtains the second load value and the second processing information to diagnose the state of the wafer (i.e., second workpiece) 11 being processed by the processing tool (i.e., second processing tool) 50 (S20).

It is to be noted that the second load value is obtained by processing the second processing information. Specifically, the controller 54 can obtain the second load value by obtaining the second processing information and then calculating the sum of load 1 to load 3 in the second processing information.

In the present embodiment, the polishing tool (i.e., first processing tool) 50 used in polishing the one surface 11a of the wafer 11 to obtain the determination conditions and the polishing tool (i.e., second processing tool) 50 used in polishing the one surface 11a of the wafer 11 and diagnosing the state at the time of processing by use of the determination conditions are the same as each other (i.e., same in kind of abrasive grains, particle size of abrasive grains, binder, diameter of the polishing pad 50b, hardness of the polishing pad 50b, and the like).

In order to make efficient use of the determination conditions as much as possible, the polishing tools 50 of the same material and the same diameter are usually used. For example, the polishing tool used in polishing the one surface 11a of the wafer 11 to obtain the determination conditions is used as it is also in diagnosing the state at the time of processing.

However, the polishing tool 50 used in obtaining the determination conditions and the polishing tool 50 used in diagnosing the state at the time of processing by use of the determination conditions may be different from each other. For example, an old polishing tool 50 and a new polishing tool 50 of the same material and the same diameter can be used.

It is to be noted that, in the present embodiment, the wafer (i.e., first workpiece) 11 polished in obtaining the determination conditions and the wafer (i.e., second workpiece) 11 polished in diagnosing the state at the time of processing by use of the determination conditions are normally wafers 11 different from each other.

Generally, the wafer (i.e., first workpiece) 11 and the wafer (i.e., second workpiece) 11 are the same as each other in thickness, size, shape, and material but different from each other in ID number, which means they are wafers 11 different from each other.

However, this is not limitative. The wafer (i.e., second workpiece) 11 may be another wafer 11 similar to the wafer (i.e., first workpiece) 11. The expression “similar” means that the wafers 11 are the same as each other in at least two or three of thickness, size, shape, and material.

While the wafer (i.e., second workpiece) 11 is being polished (i.e., processed) by the polishing tool (i.e., second processing tool) 50, simultaneously, the second load value applied to this wafer 11 and the second processing information (i.e., second processing information other than the second load value) associated with the processing of this wafer 11 are obtained.

In the present embodiment, since the first load value applied to the wafer 11 is used as the first load value, the second load value applied to the wafer 11 is similarly used as the second load value. Needless to say, in a case in which the first load value applied to the polishing tool 50 is used as the first load value, the second load value applied to the polishing tool 50 may similarly be used as the second load value.

Incidentally, the load value applied to the wafer 11 and the load value applied to the polishing tool 50 have a relation of action and reaction, and hence, it is also possible to use the first load value applied to the wafer 11 as the first load value and use the second load value applied to the polishing tool 50 as the second load value. Conversely, it is also possible to use the first load value applied to the polishing tool 50 as the first load value and use the second load value applied to the wafer 11 as the second load value.

Incidentally, the second processing information, for example, includes only load 1 (N), load 2 (N), load 3 (N), the spindle current value (A), the Z position (μm), and the temperature (°C.) each included in the determination conditions.

In this case, compared to a case in which the second processing information includes all the items (1) to (17) described above, a load on the processor 54a can be reduced. However, if the load on the processor 54a matters little, the second processing information may include all the items (1) to (17) described above.

With the progress of obtainment of the second load value and the second processing information, the controller 54 diagnoses the state of the wafer (i.e., second workpiece) 11 being processed by the processing tool (i.e., second processing tool) 50, according to the determination condition for the first load value corresponding to the second load value.

The determination condition for the first load value corresponding to the second load value means the determination condition for the first load value which condition is the same as that for the second load value. For example, when the second load value is equal to or larger than 0 (N) but equal to or smaller than 1 (N), the controller 54 diagnoses the state of the wafer 11 being processed, according to the determination condition for group 1 in which the first load value is equal to or larger than 0 (N) but equal to or smaller than 1 (N).

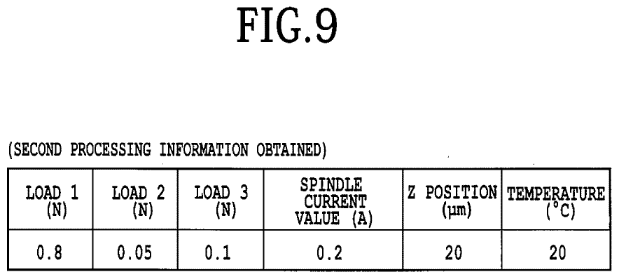

FIG. 9 is a view illustrating an example of the second processing information obtained. In the example illustrated in FIG. 9, the second load value is 0.95 (N) since load 1 is 0.8 (N), load 2 is 0.05 (N), and load 3 is 0.1 (N).

In this case, the controller 54 refers to the determination condition for group 1 (refer to FIG. 8) to determine whether or not load 1, load 2, load 3, the spindle current value, the Z position, and the temperature indicated in FIG. 9 fall within the respective numerical ranges indicated in FIG. 8.

In the example illustrated in FIG. 9, load 1 is within the range of 0.3 to 0.8 (N), load 2 and load 3 are each within the range of 0.0 to 0.1 (N), the Z position is within the range of 8 to 20 (μm), and the temperature is within the range of 20 to 30 (°C.), but the spindle current value exceeds 0.09 (A). Hence, the controller 54 diagnoses the state at the time of processing as unsatisfactory.

By contrast, if load 1 (N), load 2 (N), load 3 (N), the spindle current value (A), the Z position (μm), and the temperature (°C.) fall within the respective ranges of the corresponding items indicated in FIG. 8, the controller 54 determines that the state at the time of processing is satisfactory.

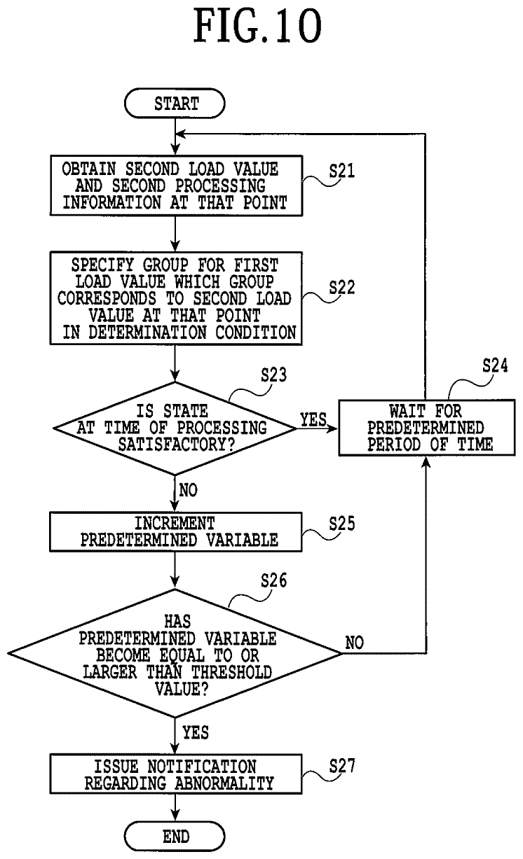

FIG. 10 is a flowchart illustrating the method for diagnosing the state of the wafer 11 being processed. It is to be noted that, in the flowchart illustrated in FIG. 10, the load value recorded as a determination condition is specified as the first load value, and the load value obtained during processing is specified as the second load value in a distinguishable manner.

At the time of diagnosing the state of this wafer 11 being processed, while the one surface 11a of the wafer 11 is polished by the polishing tool 50, the controller 54 obtains, at fixed time intervals (several to several tens of milliseconds, for example), the second load value at that point and the second processing information at that point (S21).

Then, the controller 54 specifies the group for the first load value which group corresponds to the second load value at that point in the determination condition (S22). Subsequently, the controller 54 determines whether or not the second processing information at that point satisfies the determination condition for the corresponding group (i.e., whether or not the state at the time of processing is satisfactory).

That is, the controller 54 diagnoses the state of the wafer 11 being polished by the polishing tool 50, according to the corresponding determination condition. In the present embodiment, the state at the time of polishing is diagnosed as being satisfactory when the second processing information falls within the numerical ranges of the determination condition, and the state at the time of polishing is diagnosed as being unsatisfactory when the second processing information falls outside the numerical ranges of the determination condition.

It is to be noted that the diagnosis of the state at the time of polishing is not limited to binary diagnosis of satisfactory or unsatisfactory. In addition to the determination whether or not the second processing information falls within the numerical ranges specified by the determination condition, how much the second processing information is deviated from the numerical ranges specified by the determination condition may be expressed by an index in a stepwise or consecutive manner.

When the result of the diagnosis is satisfactory (YES in S23), the controller 54 does not obtain a new second load value and new second processing information, waits for a predetermined period of time (1 (s), for example) (S24), and then returns to S21. It is to be noted that, in the case of YES in S23, the controller 54 may skip the wait for the predetermined period of time (S24) and return to S21.

When the result of the diagnosis is unsatisfactory (NO in S23), on the other hand, the controller 54 increments a predetermined variable (S25). It is to be noted that incrementing the predetermined variable may be read as increasing the count of some numerical value by a predetermined number.

After incrementing the predetermined variable (S25), the controller 54 determines whether or not the predetermined variable is equal to or larger than a threshold value. When the predetermined variable is smaller than the threshold value (NO in S26), the controller 54 waits for the predetermined period of time (S24). It is to be noted that, in the case of NO in S26, the controller 54 may skip the wait for the predetermined period of time (S24) and return to S21.

When the predetermined variable is equal to or larger than the threshold value (YES in S26), on the other hand, the controller 54 recognizes this state as an abnormality occurring in the processing and notifies the operator of the abnormality by sound, light, an image, or the like through a speaker, a light emitting diode (LED) lamp, the touch panel display 56, or the like (S27).

When the notification of the abnormality is issued, the polishing apparatus 2 suspends the processing, and unloading of the wafer 11 from the chuck table 12, inspection of the polishing apparatus 2 by the operator, and the like are performed.

It is to be noted that the processing may be suspended after the controller 54 notifies the operator of the abnormality in S27, and may further be resumed after recovery work such as dressing of the polishing pad 50b is performed. Alternatively, after the abnormality is notified, it is also possible to continue the processing with the abnormality recorded as a log without suspending the processing.

Incidentally, in S21, a moving average of each of the second load value and the second processing information may be obtained in a time span of one to several seconds. By performing determination in S23 by use of the moving averages, it is possible to reduce influence of a momentary abnormality occurring in load 1, load 2, load 3, the spindle current value, the Z position, the temperature, and the like and detect an abnormality occurring in the processing.

Since the determination conditions individually set according to the load value are used in the present embodiment, it is possible to more suitably detect whether or not an abnormality has occurred in the processing, compared to a case in which occurrence of an abnormality in the processing is detected on the basis of only whether or not the spindle current value has exceeded a threshold value.

Moreover, the state in which the polishing tool 50 and the wafer 11 are actually in contact with each other is monitored through the load value, and whether or not the determination conditions set stepwise according to the load value are satisfied is determined by use of a predetermined variable in a cumulative manner, so that highly reliable diagnosis can be provided without being affected by a momentary abnormality.

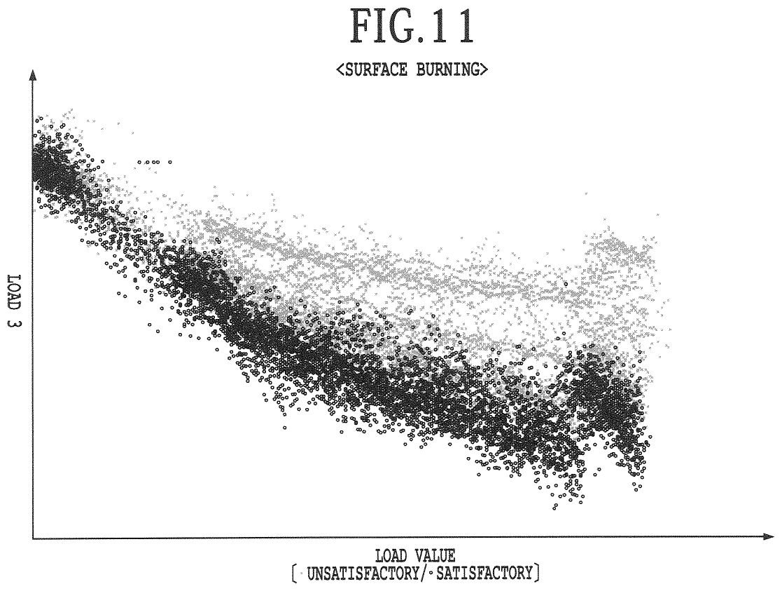

Next, with reference to FIG. 11 to FIG. 14, the reason why the load value is adopted to create the determination conditions in the present embodiment is described. The inventor of the present application has investigated the cause of occurrence of a processing defect such as surface burning or chipping as a result of polishing (i.e., processing) in the polishing apparatus 2 described above.

There are various possible causes of occurrence of a processing defect. Although having created determination conditions according to processing periods of time (early period, middle period, and later period, for example), the inventor has not been able to find out a high correlation between satisfaction of the determination conditions and satisfactory/unsatisfactory processing results. Besides, although having created determination conditions according to various parameters such as the spindle current value, the inventor has not been able to find out such a high correlation.

Hence, on an assumption that there might be a high correlation between satisfaction of the determination conditions and satisfactory/unsatisfactory processing results on the basis of the degree of direct contact between the wafer 11 and the polishing pad 50b, the inventor has created determination conditions according to the load value that is the sum of load 1 to load 3 in the manner described above.

FIG. 11 is a scatter diagram indicating presence/absence of surface burning on the basis of the load value (horizontal axis) and load 3 (vertical axis). In FIG. 11, light cross marks represent data obtained when surface burning occurred (i.e., when the state at the time of processing was unsatisfactory), and dark circle marks represent data obtained when surface burning did not occur (i.e., when the state at the time of processing was satisfactory).

FIG. 11 apparently indicates that, with the presence/absence of surface burning visualized on the basis of the load value (horizontal axis) and load 3 (vertical axis), the data obtained when the state at the time of processing was unsatisfactory and the data obtained when the state at the time of processing was satisfactory are partially overlapping but moderately separated from each other according to the load value. That is, FIG. 11 means that creating determination conditions according to the load value has a relatively high technical significance.

In addition, FIG. 11 apparently indicates such a tendency that unsatisfactory data (light cross marks) and satisfactory data (dark circle marks) are separated from each other also in a relatively low range of the load value (i.e., at an early stage of processing). That is, it is suggested that the present method is capable of detecting an abnormality already shortly after the start of the processing.

Incidentally, as illustrated in FIG. 11, the degree of separation between unsatisfactory processing data and satisfactory processing data is higher when the load value is relatively large than when the load value is relatively small. Therefore, a range of the load value within which unsatisfactory data desired to be detected (surface burning in the example of FIG. 11) is easily detected may selectively be used to diagnose the state of the wafer (i.e., second workpiece) 11 being processed (S20).

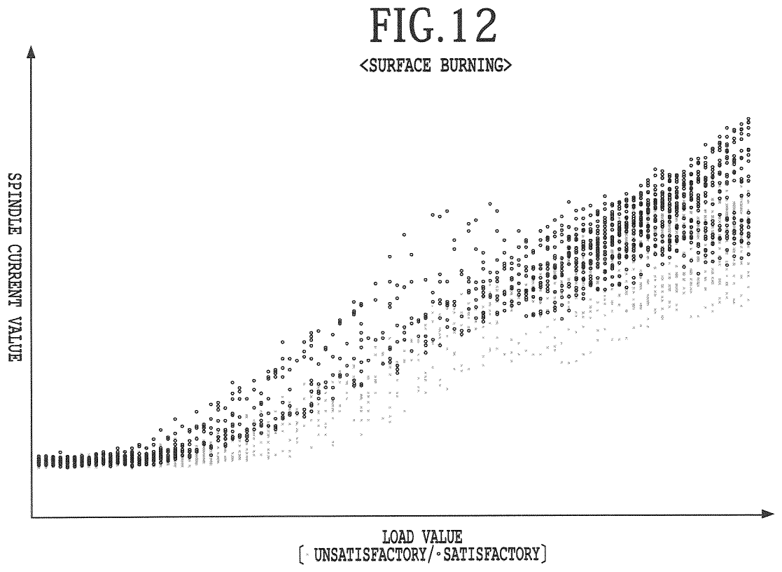

FIG. 12 is a scatter diagram indicating presence/absence of surface burning on the basis of the load value (horizontal axis) and the spindle current value (vertical axis). In FIG. 12, light cross marks represent data obtained when surface burning occurred (i.e., when the state at the time of processing was unsatisfactory), and dark circle marks represent data obtained when surface burning did not occur (i.e., when the state at the time of processing was satisfactory).

It is to be noted that a range of the load value within which unsatisfactory data desired to be detected (surface burning in the example of FIG. 12) is easily detected may selectively be used to diagnose the state of the wafer 11 being processed (S20). Meanwhile, in a case in which the horizontal axis indicates time, the spindle current value tends to increase as the polishing of the wafer 11 advances toward its end, and unsatisfactory data and satisfactory data exist in a mixed manner and are not separated from each other compared to the case illustrated in FIG. 12.

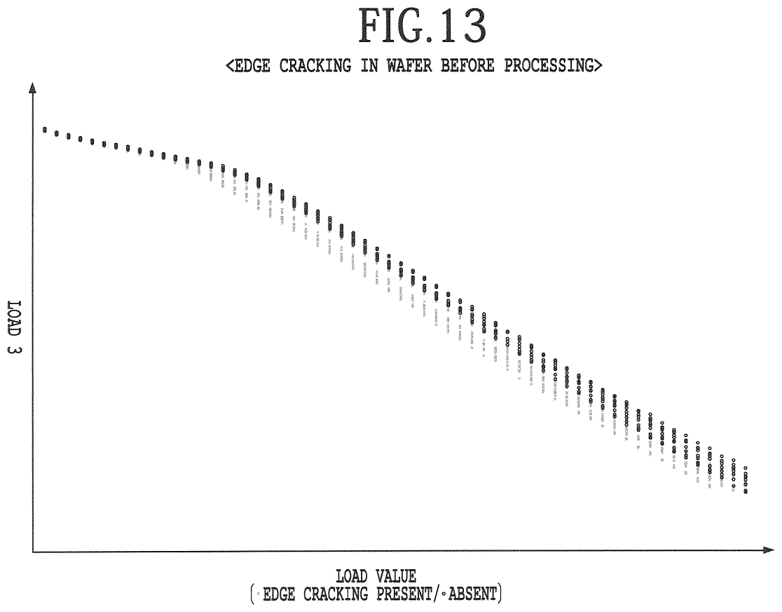

FIG. 13 is a scatter diagram indicating the load value (horizontal axis) and load 3 (vertical axis) according to presence/absence of edge cracking. In FIG. 13, light cross marks represent data obtained, through polishing of the wafer 11 by the polishing apparatus 2, when cracking (i.e., chipping) occurred at an edge of the wafer 11 (i.e., when the state before processing was unsatisfactory), and dark circle marks represent data obtained, through similar polishing, when chipping did not occur at an edge of the wafer 11 (i.e., when the state before processing was satisfactory).

In the case in which edge cracking was present (i.e., there was an abnormality) in the wafer 11 to be processed, there is a possibility that a defect such as surface burning occurs or a possibility that the polishing pad 50b has a portion thereof scooped out and needs dressing. FIG. 13 apparently indicates that load 3 with respect to the load value serves as an index for detecting presence/absence of an abnormality in the wafer 11 to be processed.

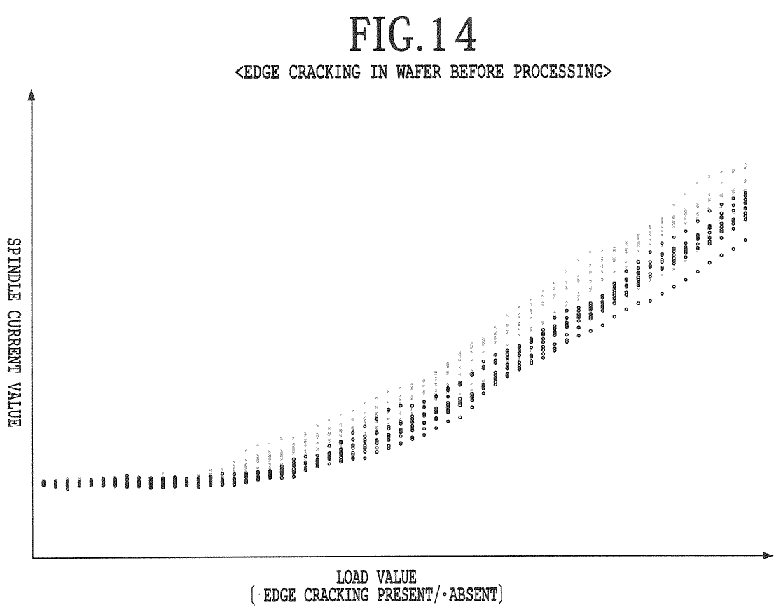

FIG. 14 is a scatter diagram indicating the load value (horizontal axis) and the spindle current value (vertical axis) according to presence/absence of edge cracking. In FIG. 14, light cross marks represent data obtained, through polishing of the wafer 11 by the polishing apparatus 2, when chipping occurred at an edge of the wafer 11 (i.e., when the state before processing was unsatisfactory), and dark circle marks represent data obtained, through similar polishing, when chipping did not occur at an edge of the wafer 11 (i.e., when the state before processing was satisfactory).

FIG. 14 also apparently indicates that the spindle current value with respect to the load value serves as an index for detecting presence/absence of an abnormality in the wafer 11 to be processed. Incidentally, the structure, method, and the like according to the embodiment described above can be implemented with appropriate changes without departing from the scope of the object of the present invention.

In the embodiment described above, the example of the dry polishing apparatus 2 is explained as the processing apparatus. However, the processing apparatus may be a wet polishing apparatus, a grinding apparatus, a bit-cutting apparatus (i.e., surface planer), a cutting apparatus, a waterjet saw, or the like.

The wet polishing apparatus is the same as the dry polishing apparatus 2 described above except that polishing liquid containing loose grains or polishing liquid not containing loose grains is supplied to the contact area between the polishing pad 50b and the workpiece.

The grinding apparatus has a configuration basically same as that of the polishing apparatus 2 but is different in that a grinding wheel (i.e., processing tool) is mounted to the spindle 38 through the mounter 48 and that polishing liquid such as pure water is supplied to a contact area between the grinding wheel and the workpiece.

The bit-cutting apparatus has a configuration basically same as that of the polishing apparatus 2 but is different in that a bit wheel (i.e., processing tool) having a diamond bit is mounted to the spindle 38 through the mounter 48.

The cutting apparatus is disposed such that a longitudinal direction of its spindle extends along a predetermined direction (Y-axis direction, for example) orthogonal to the Z axis, and an annular cutting blade (i.e., processing tool) is mounted to a tip end portion of the spindle.

In the cutting apparatus, since it is difficult to measure the load applied to the cutting blade, the load applied to the workpiece is measured by a load sensor through a chuck table or the like of the cutting apparatus. It is to be noted that the chuck table of the cutting apparatus is different from the chuck table 12 described above, and upper surfaces of a frame body and a porous plate are substantially flat and are arranged in substantially parallel to the XY plane orthogonal to the Z axis.

The waterjet saw does not have a spindle. The waterjet saw has a nozzle opening downward and a jig for holding the workpiece (i.e., holding table). To the workpiece held by the jig, liquid containing pure water and abrasive grains mixed is ejected downward from the opening of the nozzle along the Z axis, so that a through-hole can be formed in the workpiece.

Further, the nozzle and the jig holding the workpiece are moved relative to each other along the XY plane orthogonal to the Z axis, so that the workpiece can be cut along a path of the movement. In the waterjet saw, a load sensor is provided on a bottom surface of the jig, and the load applied to the workpiece is measured by the load sensor through the jig and the like.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A processing method for processing a workpiece by a processing tool, comprising:
processing a second workpiece by a second processing tool in a processing apparatus having a memory in which a determination condition for diagnosing a state at a time of processing is stored, the determination condition being created by, on a basis of a first load value applied to a first workpiece or a first processing tool and first processing information other than the first load value which information is associated with processing of the first workpiece, the first load value and the first processing information each being obtained while the first workpiece is being processed by the first processing tool, classifying the first processing information according to the first load value;
in the processing the second workpiece by the second processing tool, obtaining a second load value applied to the second workpiece or the second processing tool and second processing information other than the second load value which information is associated with the processing of the second workpiece; and
diagnosing a state of the second workpiece being processed by the second processing tool, according to the determination condition for the first load value corresponding to the second load value.

2. The processing method according to claim 1,
wherein storing the determination condition in the memory includes
classifying data including the first load value and the first processing information each obtained at the time of processing the first workpiece into a plurality of groups according to the first load value, and
creating the determination condition for each group on a basis of the data having been classified into the plurality of groups.

3. The processing method according to claim 2,
wherein the storing the determination condition in the memory of the processing apparatus includes,
before the classification of the data into the plurality of groups, selecting and keeping part of the data which part is to be used in the classification into the plurality of groups.

4. The processing method according to claim 1,
wherein the first processing tool and the second processing tool each have a polishing pad,
the determination condition is obtained when one surface of the first workpiece is polished by the first processing tool, and,
in the diagnosing the state of the second workpiece being processed, one surface of the second workpiece is polished by the second processing tool, and the state of the second workpiece being polished by the second processing tool is diagnosed according to the determination condition.

5. A method for creating a determination condition, comprising:
classifying data including a load value applied to a workpiece or a processing tool and processing information other than the load value which information is associated with processing of the workpiece, the load value and the processing information each being obtained while the workpiece is being processed by the processing tool, into a plurality of groups according to a magnitude of the load value; and,
on a basis of the data having been classified into the plurality of groups, creating a determination condition for diagnosing a state of the workpiece being processed, for each group.

6. A processing apparatus that processes a workpiece, comprising:
a holding table for holding the workpiece;
a spindle to which a processing tool is mounted; and
a controller that has a processor and a memory and controls operation of the holding table and the spindle,
wherein stored in the memory is a determination condition for diagnosing a state at a time of processing, the determination condition being created by, on a basis of a first load value applied to a first workpiece or a first processing tool and first processing information other than the first load value which information is associated with processing of the first workpiece, the first load value and the first processing information each being obtained while the first workpiece is being processed by the first processing tool, classifying the first processing information according to the first load value, and
the controller
obtains, in processing a second workpiece by a second processing tool mounted to the spindle, a second load value applied to the second workpiece or the second processing tool and second processing information other than the second load value which information is associated with the processing of the second workpiece, and
diagnoses a state of the second workpiece being processed by the second processing tool, according to the determination condition for the first load value corresponding to the second load value.
